(19) United States
(12) Patent Application Publication
(10) Pub. No.: US 2015/0275336 A1
(43) Pub. Date: Oct. 1, 2015

(54) ALUMINUM ALLOY FOR VEHICLE AND PART OF VEHICLE

(71) Applicant: HONDA MOTOR CO., LTD., Tokyo (JP)

(72) Inventor: Yukihide Fukuda, Wako-shi (JP)

(73) Assignee: HONDA MOTOR CO., LTD., Tokyo (JP)

(21) Appl. No.: 14/434,260

(22) PCT Filed: Jul. 29, 2013
(86) PCT No.: PCT/JP2013/070433

§ 371 Date: Apr. 8, 2015

(30) Foreign Application Priority Data
Oct. 17, 2012 (JP) 2012-229604

(51) Int. Cl. C22C 21/02; B60B 1/02; B60B 21/00

(52) U.S. Cl. CPC C22C 21/02; B60B 21/00; B60B 1/0261; B60B 2360/104; B60Y 2200/12

(57) ABSTRACT

There are provided aluminum alloy for a vehicle and a part for a vehicle in which toughness suitable for the part for a vehicle can be secured even when aluminum material containing impurities such as Fe, Cu or the like is used. The aluminum alloy for a vehicle contains Fe in the range from not less than 0.2 wt % to not more than 1.0 wt %, Mn in the range from not less than 0.01 wt % to not more than 0.7 wt %, Si and Cu, and Al and unavoidable impurities as residuals, and the size of intermetallic compounds is equal to 30 μm or less.

### TECHNICAL FIELD

The present invention relates to aluminum alloy for vehicles and parts of the vehicles.

### BACKGROUND ART

Aluminum die-casting alloy (also called as aluminum primary alloy) in which some elements are added to virgin ingot of aluminum has been proposed as material for a part such as a wheel for a vehicle or a motorcycle or the like to which both of high strength and high toughness are required (see Patent Document 1, for example).

### PRIOR ART DOCUMENT

### Patent Document

Patent Document 1: JP-A-2003-27169

### SUMMARY OF THE INVENTION

### Problem to be Solved by the Invention

When virgin ingot of aluminum such as aluminum die-casting alloy as described in the Patent Document 1 is used, it has been desired to manufacture regenerated ingot of aluminum (also called as aluminum secondary alloy) with recycled material (scraps) as raw material because the virgin ingot of aluminum is expensive and much CO₂ is discharged in the manufacturing process of the virgin ingot of aluminum. However, when the regenerated ingot of aluminum material is used, Fe, Cu or the like which reduces the toughness (elongation percentage) is contaminated. Therefore, it has been difficult to use regenerated ingot of aluminum as material to which toughness is required.

The present invention has been implemented in view of the foregoing situation, and has an object to provide aluminum alloy for vehicles that can secure toughness suitable for vehicle parts even when aluminum material containing impurities such as Fe, Cu or the like is used, and parts of the vehicle.

### Means of Solving the Problem

In order to attain the above object, aluminum alloy for vehicles according to the present invention is characterized in that the weight percentage of Fe (iron) is in the range from not less than 0.2 wt % to not more than 1.0 wt %, the weight percentage of Mn (manganese) is in the range from not less than 0.01 wt % to not more than 0.7 wt %, Si (silicon) and Cu (copper) are contained, Al (aluminum) and unavoidable impurities are contained as residuals and an intermetallic compound size is equal to 30 μm or less.

According to the present invention, aluminum alloy for vehicles which has toughness suitable for vehicle parts can be obtained by using aluminum raw material containing Fe, Cu or the like as impurities such as regenerated aluminum ingot material. When Fe is contained, an effect of preventing seizure in die-casting can be obtained, and thus the present invention is suitably applied to manufacturing of parts for vehicles by die-casting.

Furthermore, in the aluminum alloy for vehicles, the weight percentage of Fe is in the range from not less than 0.3 wt % to not more than 0.9 wt %, the weight percentage of Mn is in the range from not less than 0.2 wt % to not more than 0.5 wt %, the intermetallic compound size is equal to 25 μm or less, and intermetallic compounds are formed in a lump shape.

In this case, aluminum alloy for vehicles which is more excellent in toughness can be obtained.

It is preferable for the aluminum alloy for vehicles that the weight percentage of Fe is in the range from not less than 0.3 wt % to not more than 0.8 wt %, the weight percentage of Mn is in the range from not less than 0.2 wt % to not more than 0.4 wt %, Mg (magnesium) and Zn (zinc) are contained, and the intermetallic compound size is equal to 15 μm or less.

In this case, even when Mg and Zn derived from regenerated aluminum ingot material or the like are contained, aluminum alloy for vehicles which is more excellent in toughness can be obtained.

A vehicle part according to the present invention is configured by using the aluminum alloy for vehicles described above.

A vehicle part according to the present invention is configured by using aluminum alloy for vehicles in which the weight percentage of Fe is in the range from not less than 0.2 wt % to not more than 1.0 wt %, the weight percentage of Mn is in the range from not less than 0.01 wt % to not more than 0.7 wt %, Si and Cu are contained, Al and unavoidable impurities are contained as residuals, wherein an intermetallic compound size is equal to 30 μm or less.

According to the present invention, a vehicle part having preferable toughness can be provided by using aluminum raw material containing Fe, Mn, Cu or the like as impurities such as regenerated aluminum ingot material.

It is preferable in the vehicle part described above that the aluminum alloy for vehicles containing Fe in the range from not less than 0.3 wt % to not more than 0.9 wt % and Mn in the range from not less than 0.2 wt % to not more than 0.5 wt % is used, the intermetallic compound size is equal to 25 μm or less, and intermetallic compounds are formed in a lump shape.

In this case, a vehicle part having more excellent toughness can be obtained.

It is more preferable in the vehicle part described above that the aluminum alloy for vehicles contains Fe in the range from not less than 0.3 wt % to not more than 0.8 wt %, Mn in the range from not less than 0.2 wt % to not more than 0.4 wt %, and Mg and Zn, and the intermetallic compound size is equal to 15 μm or less.

In this case, even when Mg and Zn derived from the regenerated aluminum ingot material or the like are contained, a vehicle part having more excellent toughness can be obtained.

The vehicle part may be formed by subjecting the aluminum alloy for vehicles to die-casting.

Furthermore, the plate thickness of the vehicle part may be set to 15 mm or less.

According to the present invention, by shortening the solidification time under casting for a vehicle part manufactured by casting aluminum raw material, growth of needle-like intermetallic compounds which degrades toughness can be suppressed, and a vehicle part having more preferable characteristics can be provided.

The vehicle part may be a wheel (10) for a motorcycle.

According to the present invention, a wheel for a motor cycle which has preferable toughness can be obtained.

Furthermore, the vehicle part may be a wheel (10) for a motorcycle in which the thicknesses of a spoke (15) and a rim (17) are set to 15 mm or less.

### Effect of the Invention

According to the present invention, aluminum alloy for vehicles whose toughness is suitable for vehicle parts can be obtained by using aluminum raw material containing Fe, Cu or the like as impurities such as regenerated aluminum ingot material. Furthermore, when Fe is contained, the effect of preventing seizure under die-casting can be obtained. Therefore, the present invention is suitably applied to manufacturing of parts for vehicles by die-casting. Furthermore, even when Mg and Zn derived from the regenerated aluminum ingot material or the like are contained, aluminum alloy for vehicles whose toughness is more excellent can be obtained.

Furthermore, parts for vehicles which has suitable toughness can be provided by using aluminum raw material containing Fe, Mn, Cu or the like impurities such as regenerated aluminum ingot material, and a wheel for a motorcycle which has suitable toughness can be provided.

Still furthermore, the solidification time under casting can be shortened by reducing the plate thickness of a vehicle part manufactured by casting aluminum raw material, and the growth of needle-like intermetallic compounds which degrades the toughness can be suppressed. Therefore, vehicle parts having more suitable characteristics can be provided.

### BRIEF DESCRIPTION OF THE DRAWINGS

FIG. 1 is a diagram showing the construction of a wheel for a motorcycle according to an embodiment of the present invention, wherein (A) is a plan view and (B) is a cross-sectional view.

FIG. 2 is a graph showing an example of the correlation between intermetallic compound size and toughness of aluminum alloy for vehicles.

FIG. 3 is a graph showing the effect of the amount of Fe on the characteristics of aluminum alloy for vehicles, wherein (A) shows a correlation between the amount of Fe and the intermetallic compound size, and (B) shows a correlation between the amount of Fe and the toughness.

FIG. 4 is a graph showing the effect of the amount of Mn on the characteristics of aluminum alloy for vehicles, wherein (A) shows a correlation between the amount of Mn and the intermetallic compound size, and (B) shows a correlation between the amount of Mn and the toughness.

FIG. 5 is an optical photomicrograph of the structure of an aluminum die-cast product when the amount of Mn is set to 0%.

FIG. 6 is an optical photomicrograph of the structure of an aluminum die-cast product when the amount of Mn is set to 0.3%.

FIG. 7 is an optical photomicrograph of the structure of an aluminum die-cast product when the amount of Mn is set to 0.8%.

FIG. 8 is a graph showing the correlation between the amount of Cu and toughness.

### MODES FOR CARRYING OUT THE INVENTION

An embodiment according to the present invention will be described hereunder with reference to the drawings.

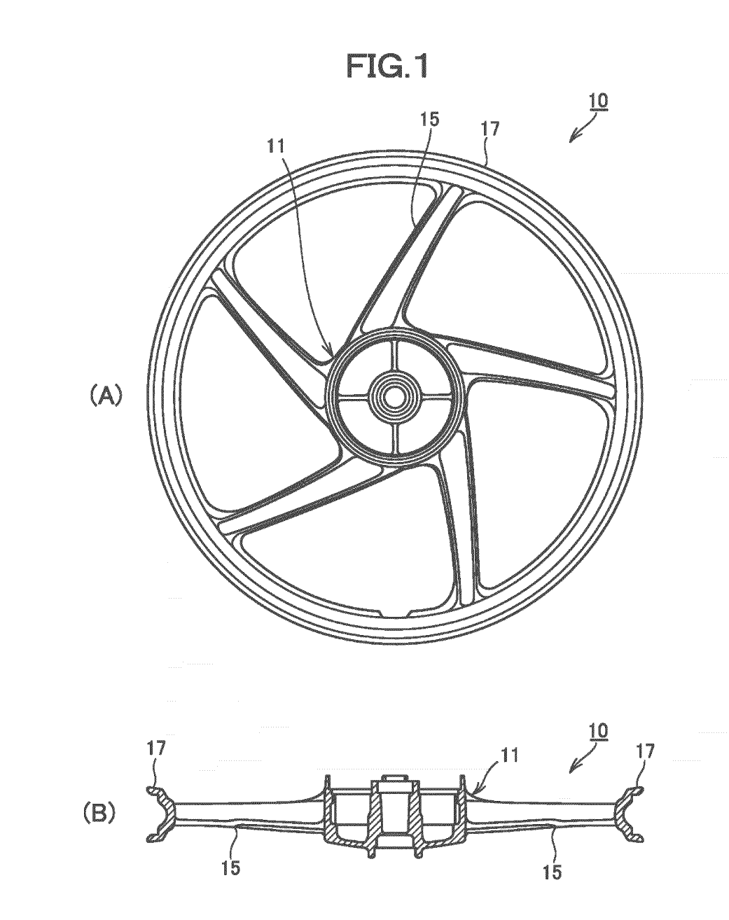

FIG. 1 is a diagram showing the construction of a wheel 10 for a motorcycle according to an embodiment to which the present invention is applied, wherein (A) is a plan view and (B) is a cross-sectional view.

The wheel 10 for the motorcycle shown in FIG. 1 has a hub 11, plural spokes 15 extending radially from the hub 11, and a rim 17 on which a tire (not shown) is mounted, the hub 11, the plural spokes 11 and the rim 17 being integrally formed by die-casting. As shown in FIG. 1(B) the spokes 15 and the rim 17 are designed to be small in thickness.

An elongation characteristic (toughness) is required to aluminum alloy for vehicles which is used for vehicle parts such as a wheel 10 for motorcycle, etc. It has been generally known that the toughness degrades as the content of Fe as impurities contained in aluminum material increases. the inventors of this application have found that the degradation of the toughness is caused by the effect of intermetallic compounds formed between proeutectic (primarily crystallized) α-Al crystals. The intermetallic compounds are Al—Fe—Si eutectic crystal, Al—Fe—Mn—Si eutectic crystal, etc. contained in eutectic crystals which coagulate after proeutectic, and these materials are generated at a higher temperature than α-Si eutectic crystal. These intermetallic compounds are formed to have various shapes in accordance with the composition of aluminum alloy, particularly, the amounts of Fe and Mn, and formed in a needle-like shape, a planar shape or a lump-like shape. The inventors have found that the toughness of cast products degrades as the sizes of these intermetallic compounds containing Fe increase. The size of the intermetallic compound means neither the area nor the volume, but means the maximum length in any one direction. Accordingly, when the intermetallic compound grows in a needle-like shape or a planar shape, the size of the intermetallic compound is liable to increase.

In order to reduce the size of the intermetallic compound, it is effective to increase the cooling speed without inducing occurrence of misrun. As the thickness of the cast product is smaller, the cooling state under casting can be controlled with high precision. For example, the spoke 15 and the rim 17 of the motorcycle wheel 10 are configured to be thin in thickness, and thus the toughness at these sites can be expected to be enhanced. The inventors have found that production of large-size intermetallic compounds can be suppressed by setting the thicknesses of the spoke 15 and the rim 17 to 15 mm or less, so that excellent toughness can be obtained.

As described above, the shape and size of the intermetallic compound are also affected by the composition of aluminum alloy. When regenerated aluminum ingot material is used as a raw material, there is some effect of Fe, Mn, Cu or the like which contaminates as impurities.

As the regenerated aluminum ingot material is known rolled scraps containing aluminum sash (extruded material) or rolled (wrought) aluminum material as a main component, or casting scraps containing casting chips or materials shredded by a shredder out of non-iron metal scraps.

Table 1 shows an example of the regenerated ingot aluminum materials which are popularly distributed.

TABLE 1

| | | COMPOSITION (WEIGHT %) | | | | | | |
|---|---|---|---|---|---|---|---|---|
| TYPE | | Si | Mg | Mn | Cu | Zn | Fe | Al |
| ROLLED SCRAPS | SASH | 1.0 | 0.4 | 0.1 | 0.2 | 0.4 | From | Residual |
| | (EXTRUDED | | | or | or | | 0.6 | |
| | MATERIALS) | | | less | less | | to | |
| | | | | | | | 0.8 | |
| | ROLLED | 1.0 | From | 0.3 | From | 1.5 | From | ↑ |
| | MATERIALS | | 0.3 | or | 0.7 | | 0.9 | |
| | | | to | less | to | | to | |
| | | | 0.5 | | 1.0 | | 1.1 | |
| CASTING SCRAPS | CASTING | 7.0 | From | 0.2 | From | From | From | ↑ |
| | CHIPS | | 0.3 | or | 2.0 | 1.2 | 0.9 | |
| | | | to | less | to | to | to | |
| | | | 0.4 | | 2.5 | 1.5 | 1.1 | |
| | SHREDDER | From | From | 0.2 | From | From | From | ↑ |
| | | 6.0 | 0.2 | | 1.5 | 1.2 | 0.8 | |
| | | to | to | | to | to | to | |
| | | 7.0 | 0.4 | | 2.0 | 1.5 | 1.0 | |

When the rolled scraps or the casting scrapes in the example shown in table 1 are arbitrarily selected or mixed, and used as aluminum alloy raw material for vehicles, the aluminum raw material contains Si, Fe, Mg, Mn, Cu, Zn or the like. These regenerated aluminum ingot materials may be mixed with virgin aluminum ingot material and used as aluminum raw material. However, in this case, contamination of impurities is also unavoidable.

Fe degrades the toughness of casting products of Al—Si type alloy. When the amount of Fe is large, a large amount of needle-like Al—Si—Fe-based intermetallic compounds are produced, and thus the toughness is degraded. On the other hand, Fe has an effect of preventing occurrence of seizure in dies for die-cast products.

When Mn is added to Fe-contained Al—Si-based alloy, it has an effect of producing aggregated Al—Si—Fe—Mn-based intermetallic compounds and suppressing production of needle-like or planar Al—Si—Fe-based intermetallic compounds described above. On the other hand, when the amount of Mn is large, the size of the intermetallic compounds increases, and the toughness of casting products degrades.

Furthermore, Cu is considered to serve as impurities which degrade the toughness of casting products and reduce corrosion resistance.

Zn is considered to serve as impurities which reduce corrosion resistance.

Mg has an effect of enhancing tensile strength and proof strength, but the toughness degrades as the amount of Mg increases.

Si has an effect of enhancing fluidity of molten metal during casting of aluminum alloy.

The inventors have made various studies of the composition of aluminum alloy for vehicles which contains regenerated aluminum ingot material as raw material, and the size of intermetallic compounds, and have found that aluminum die-cast products whose toughness is suitable as parts for vehicles can be obtained under the condition that the weight percentage of Fe is in the range from not less than 0.2 wt % to not more than 1.0 wt %, the weight percentage of Mn is in the range from not less than 0.01 wt % to not more than 0.7 wt %, Si and Cu are contained, Al and unavoidable impurities are contained as residuals and the size of intermetallic compounds is equal to 30 μn or less. In this case, as indicated with respect to examples described later, aluminum die-cast products which have an elongation of at least 5% or more can be obtained.

Accordingly, even when impurities such as Fe, Mn, Cu or the like derived from regenerated aluminum ingot material or the like are contained, aluminum die-cast products having toughness suitable as vehicle parts can be obtained.

Contamination of Fe amount is unavoidable when regenerated aluminum ingot material is used. However, when the amount of Fe is set to 0.2% or more, raw materials containing a lot of regenerated aluminum ingot material can be utilized. Furthermore, when Fe is contained, it has an effect of preventing seizure in die-casting. Therefore, contamination of Fe is preferable when vehicle parts are manufactured by aluminum die-casting.

When Fe is in the range from not less than 0.3% to not more than 0.9%, Mn is in the range from not less than 0.2% to not more than 0.5%, the size of intermetallic compounds is equal to 25 μm or less and the intermetallic compounds are formed in a lump-like shape, scraps containing a large amount of Fe can be utilized as an effect of increasing the lower limit value of Fe, and also aluminum die-cast products which have excellent toughness as vehicle parts can be obtained. In this case, as indicated with respect to examples described later, aluminum die-cast products having an elongation of at least 7% or more can be obtained. By setting the amount of Fe to 0.3% or more, a larger amount of regenerated aluminum ingot material can be used as raw material. Furthermore, under the condition that Fe: 0.3-0.8%, Mn: 0.2-0.4%, Mg and Zn are contained and the size of intermetallic compounds is equal to 15 μm or less, aluminum die-cast products having toughness which is more excellent as vehicle parts can be obtained even when Mg and Zn derived from regenerated aluminum ingot material or the like is contained. In this case, as indicated in the examples described later, aluminum die-cast products having an elongation of at least 10% or more can be obtained.

Furthermore, with respect to the amount of Si, when the weight of Si is equal to 6.0 wt % or more, fluidity of molten metal can be made good, and when the weight of Si is equal to 12.0 wt % or less, the elongation (toughness) of die-cast products can be secured. Therefore, it is preferable that the amount of Si is set in the range from not less than 6.0% to not more than 12.0%.

With respect to the amount of Cu, the amount is preferable small because Cu degrades the toughness. However, it is difficult to avoid contamination of Cu when regenerated aluminum ingot material is used as raw material. When the amount of Cu is set to 1.0% or less in the above composition, regenerated aluminum ingot material can be used as raw material, and aluminum die-cast products having suitable toughness can be provided. In other words, contamination of Cu is permissible insofar as the amount of Cu is equal to 1.0% or less.

With respect to Mg, it is difficult to avoid contamination of Mg derived from regenerated aluminum ingot material. When the amount of Mg is set in the range from not less than 0.05% to not more than 0.4% in the above composition, the regenerated aluminum ingot material can be used as raw material, and aluminum die-cast products having suitable toughness can be provided.

With respect to Zn, it is difficult to avoid contamination of Zn derived from regenerated aluminum ingot material. When the amount of Zn is set in the range from not less than 0.3% to not more than 1.0% in the above composition, the regenerated aluminum ingot material can be used as raw material, and aluminum die-cast products having suitable toughness can be provide.

### EXAMPLES

Examples of the present invention will be described in detail, but the present invention should not be limitedly interpreted on the basis of the description of the examples.

In the following examples, aluminum die-cast products were experimentally produced by using aluminum alloy samples comprising twenty four types of compositions of examples 1 to 9 to which the present invention is applied, comparative examples 1 to 5 as comparative targets and reference examples 1 to 6, and estimated.

Specifications, estimation results of physical properties and estimations of the respective examples shown in Table 2.

TABLE 2

| | | | | | | | | | MEASUREMENT | |
|---|---|---|---|---|---|---|---|---|---|---|
| | | | | | | | | | RESULTS | |
| | | | | | | | | | INTER | |
| | | | | | | | | | METALLIC | |
| | | | | | | | | | COMPOUND | |
| | | COMPOSITION (WT %) | | | | | | | SIZE | ELONGATION |
| No. | | Si | Mg | Mn | Fe | Zn | Cu | Al | [μM] | (%) |
| 1 | Example 1 | 8.5 | 0.15 | 0.20 | 0.8 | 0.80 | 0.6 | RESIDUAL | 14 | 9.8 |
| 2 | Example 2 | 8.5 | 0.15 | 0.25 | 0.8 | 0.80 | 0.6 | ↑ | 7 | 11.5 |
| 3 | Example 3 | 8.5 | 0.15 | 0.30 | 0.8 | 0.80 | 0.6 | ↑ | 7 | 11.4 |
| 4 | Example 4 | 8.5 | 0.15 | 0.36 | 0.8 | 0.80 | 0.6 | ↑ | 7 | 11.8 |
| 5 | Example 5 | 8.5 | 0.15 | 0.40 | 0.8 | 0.80 | 0.6 | ↑ | 12 | 10.3 |
| 6 | Example 6 | 8.5 | 0.15 | 0.60 | 0.8 | 0.80 | 0.6 | ↑ | 14.5 | 9.5 |
| 7 | Example 7 | 8.5 | 0.15 | 0.35 | 0.2 | 0.80 | 0.6 | ↑ | 0 | 16 |
| 8 | Example 8 | 8.5 | 0.15 | 0.35 | 0.4 | 0.80 | 0.6 | ↑ | 5.8 | 12.3 |
| 9 | Example 9 | 8.5 | 0.15 | 0.35 | 0.8 | 0.80 | 0.6 | ↑ | 7.2 | 11.5 |
| 10 | Comparative | 8.5 | 0.15 | 0.00 | 0.1 | 0.80 | 0.6 | ↑ | 3.4 | 14 |
| | Example 1 | | | | | | | | | |
| 11 | Comparative | 8.5 | 0.15 | 0.00 | 0.4 | 0.80 | 0.6 | ↑ | 10 | 11.2 |
| | Example 2 | | | | | | | | | |
| 12 | Comparative | 8.5 | 0.15 | 0.00 | 0.8 | 0.80 | 0.6 | ↑ | 21.5 | 5.5 |
| | Example 3 | | | | | | | | | |
| 13 | Comparative | 8.5 | 0.15 | 0.35 | 1.3 | 0.80 | 0.6 | ↑ | 48 | 5 |
| | Example 4 | | | | | | | | | |
| 14 | Comparative | 8.5 | 0.15 | 1.00 | 0.8 | 0.80 | 0.6 | ↑ | 31.5 | 7.3 |
| | Example 5 | | | | | | | | | |
| 15 | Reference | 8.5 | 0.15 | 0 | 0 | 0 | 0 | ↑ | — | 14 |
| | Example 1 | | | | | | | | | |
| 16 | Reference | 8.5 | 0.15 | 0 | 0 | 0 | 0.31 | ↑ | — | 12.5 |
| | Example 2 | | | | | | | | | |
| 17 | Reference | 8.5 | 0.15 | 0 | 0 | 0 | 0.62 | ↑ | — | 11.3 |
| | Example 3 | | | | | | | | | |
| 18 | Reference | 8.5 | 0.15 | 0 | 0 | 0 | 0.9 | ↑ | — | 10.5 |
| | Example 4 | | | | | | | | | |
| 19 | Reference | 8.5 | 0.15 | 0 | 0 | 0 | 1.2 | ↑ | — | 9.2 |
| | Example 5 | | | | | | | | | |
| 20 | Reference | 8.5 | 0.15 | 0 | 0 | 0 | 1.5 | ↑ | — | 8.1 |
| | Example 6 | | | | | | | | | |

### Examples

In the example 1, aluminum alloy was dissolved in aluminum raw material to add various kinds of elements, thereby adjusting molten metal which has chemical component weight ratio of Si: 8.5%, Mg: 0.15%, Mn: 0.20%, Fe: 0.80%, Zn: 0.80% and Cu: 0.6% and contains residuals of Al and unavoidable impurities.

Subsequently, the molten metal was subjected to die-casting by using a normal die-casting machine having dies for forming a wheel for a two-wheel vehicle, thereby manufacturing a wheel for a motorcycle.

The rim and spokes of the wheel for the two-wheel vehicle were cut and machined to make tensile test pieces, and the mechanical characteristics of the tensile test pieces were measured by a tensile test machine.

Furthermore, the size of intermetallic compounds was measured on the basis of optical photomicrographs of cutting planes of the rim and spokes of the wheel for the motorcycle.

The example 1 has a result of the elongation of 9.8% and the intermetallic compound size of 14 μm.

With respect to the examples 2 to 9 and the comparative examples 1 to 5, molten metal which contained Si, Mg, Mn, Fe, Zn and Cu so as to obtain the composition ratios described in Table 2 and also contained Al and unavoidable impurities as residuals was adjusted, and a wheel for a motorcycle was formed by die-casting as in the case of the example 1. The same test pieces as the example 1 were created from the wheel for the motorcycle, and the measurement based on the tensile test machine and the measurement of the intermetallic compound size based on optical photomicrographs were performed. The measurement results of the respective examples and the comparative examples are shown in Table 2.

### Reference Examples

In the reference examples 1 to 6, molten metal which contained Si, Mg and Cu so as to have the composition ratios described in Table 2 and also contained Al and unavoidable impurities as residuals was adjusted, and a wheel for a motorcycle was formed by die-casting as in the case of the example 1. The reference examples 1 to 6 did not contain Mn, Fe and Zn because they were examples for considering the effect of the amount of Cu on the toughness of aluminum die-cast products and the intermetallic compound size.

The same test pieces as the example 1 were created from a die-casted wheel for a motorcycle, and the measurement based on the tensile test machine and the measurement of the intermetallic compound size based on optical photomicrographs were performed. The measurement results of the respective reference examples are shown in Table 2.

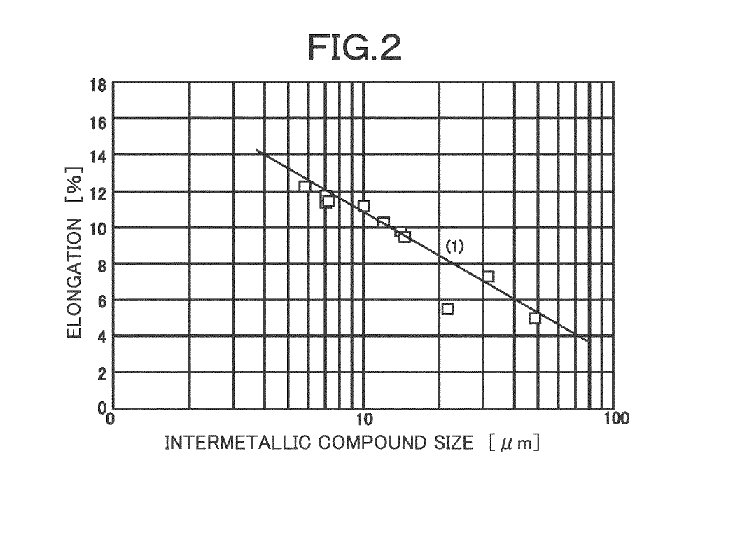

FIGS. 2 to 4 are graphs showing the characteristics of aluminum alloy for vehicles according to the examples and the comparative examples.

FIG. 2 shows the correlation between the intermetallic compound size and the toughness with respect to the examples 1 to 9 and the comparative examples 1 to 5. In FIG. 2, the abscissa axis represents a logarithmic scale. In FIG. 2, (1) represents a linearly approximating curve line.

As shown in FIG. 2, there is identified a correlation that the elongation is larger as the intermetallic compound size is smaller. On the basis of the plots of the respective examples and the comparative examples and the approximate curve (1), it is obvious that the elongation is equal to 6% or more when the intermetallic compound size is equal to 30 μm or less, and thus the intermetallic compound size is preferably equal to 30 μm or less. Since the elongation is equal to 7% or more when the intermetallic compound size is equal to 25 μm or less, and thus this is more preferable. When the intermetallic compound size is equal to 15 μm or less, the elongation is equal to 10% or more, and thus this is most preferable.

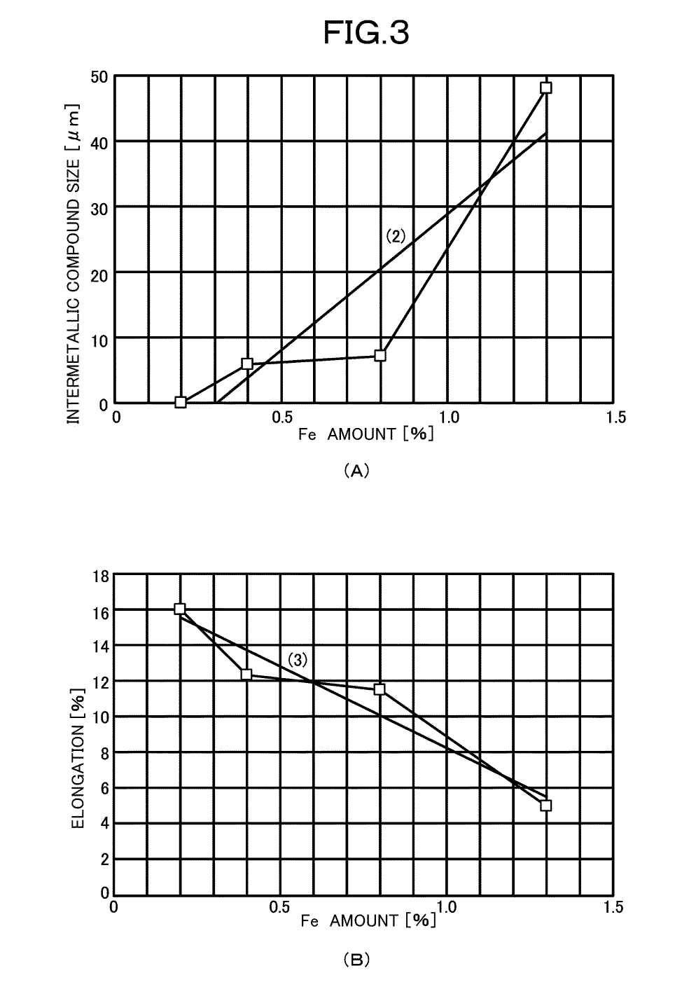

FIG. 3 is a graph showing the effect of the Fe amount on the characteristics of aluminum alloy for vehicles, wherein (A) shows a correlation between the Fe amount and the intermetallic compound size with respect to the examples and the comparative examples, and (B) shows a correlation between the Fe amount and the toughness. In FIGS. 3(A), (B), measurement results of the examples 7, 8 and 9 and the comparative example 4 are plotted so that the conditions other than the Fe amount are coincident among these examples. (2) of FIG. 3(A) and (3) of FIG. 3(B) represent linearly approximated curves.

As shown in FIG. 3(A), there is identified a correlation that the intermetallic compound size is larger as the Fe amount is larger. In FIG. 3(B), it is obvious that more excellent elongation can be obtained as the Fe amount is smaller. This conforms with the fact that more excellent elongation is obtained as the intermetallic compound size is smaller.

On the basis of the approximate curve (2) of FIG. 3(A) and the respective plots, in order to set the intermetallic compound size to 30 μm or less, the Fe amount is preferably set to 1.0% or less. In this case, the elongation is equal to 8% or more. Furthermore, on the basis of the approximate curve (3) of FIG. 3(B) and the respective plots, when the Fe amount is equal to 0.9% or less, excellent toughness providing an elongation of 9% or more can be obtained, and thus this is more preferable. Furthermore, on the basis of the respective plots in FIGS. 3(A) and (B), it is obvious that the most preferable result is obtained when the Fe amount is equal to 0.8% or less.

Furthermore, even when the Fe amount is equal to 0.2% or more, the intermetallic compound size and the toughness are in preferable ranges, and the same result is obtained even when the Fe amount is equal to 0.3% or more. Accordingly, from the viewpoint of utilization of regenerated aluminum ingot material, the Fe amount is preferably equal to 0.2% or more, and more preferably equal to 0.3% or more.

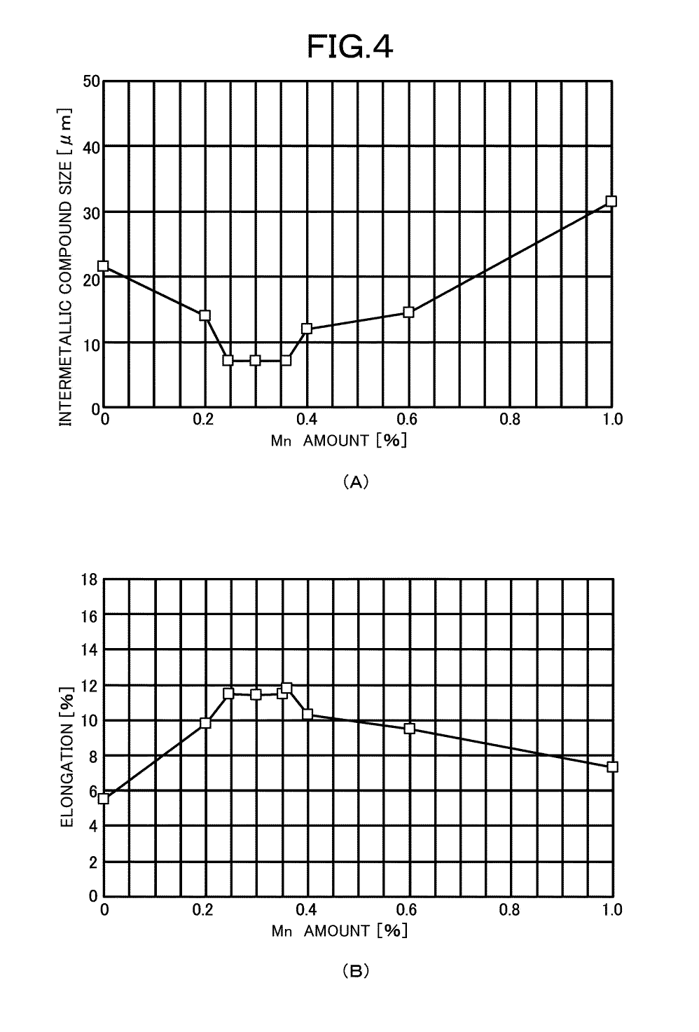

FIG. 4 is a graph showing the effect of the Mn amount on the characteristics of aluminum alloy for vehicles, wherein (A) shows a correlation between the Mn amount and the intermetallic compound size with respect to the examples and the comparative examples, and (B) shows a correlation between the Mn amount and the toughness. In FIGS. 4(A) and (B), measurement results of the examples 1 to 6 and 9 and the comparative examples 3 and 5 are plotted so that the conditions other than the Mn amount are coincident among these examples.

As shown in FIGS. 4(A) and (B), under the condition that the Mn amount is in the range from not less than 0.2% to not more than 0.4%, the intermetallic compound size is particularly small, and the elongation has high values. When the Mn amount increases or decreases from the above range, the intermetallic compound size increases and the elongation decreases. From this result, when the Mn amount is in the range from not less than 0.2% to not more than 0.4%, an elongation of substantially 10% or more can be obtained, and the intermetallic compound size can be reduced to 10 μm or less. Therefore, this condition is most preferable. Furthermore, when the Mn amount is in the range from not less than 0.2% to not more than 0.5%, an elongation of 9% or more can be obtained, and the intermetallic compound size can be reduced to 15 μm. Therefore, this condition is preferable. Still furthermore, when the Mn amount is set to 0.7% or less, an elongation of 5% or more can be obtained, and the intermetallic compound size can be reduced to substantially 20 μm or less. Therefore, this condition is also preferable.

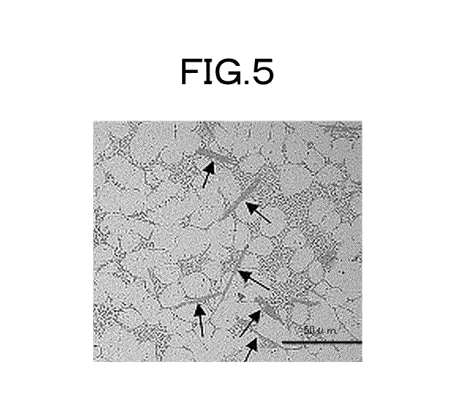

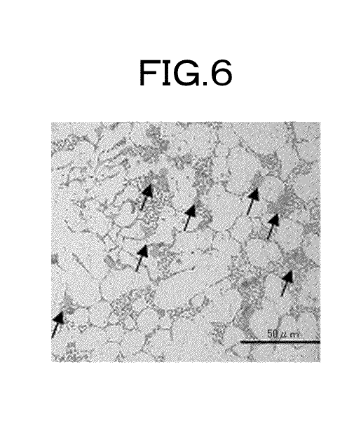

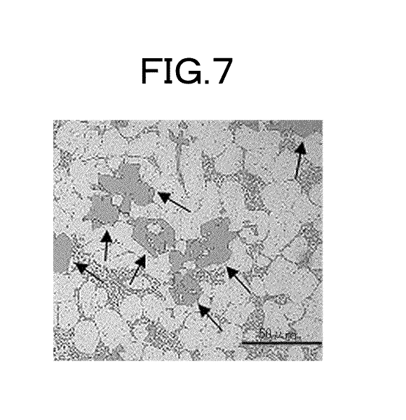

FIGS. 5 to 7 show optical photomicrographs showing the effect of the Mn amount in the structure of the aluminum die-cast products, wherein FIG. 5 shows a case where the Mn amount is set to 0%, FIG. 6 shows a case where the Mn amount is set to 0.3% and FIG. 7 shows a case where the Mn amount is set to 0.8%. The other compositions are Si: 8.5%, Mg: 0.15% and Fe: 0.8%. These three photomicrographs are identical in magnification.

In the structure of FIG. 5, crystallization of planar intermetallic compounds is observed (see arrows in FIG. 5), and some crystals which are longer than the scale (50 μm) of FIG. 5 are observed.

On the other hand, in the structure of FIG. 6, intermetallic compounds are formed (aggregated) in a lump shape (arrows in FIG. 6). The reason for this is considered as follows. Al—Si—Fe—Mn-based intermetallic compounds are generated due to addition of Mn, and thus generation of needle-like or planar Al—Si—Fe-based intermetallic compounds is suppressed.

Crystallization of needle-like or planar intermetallic compounds is not observed in the structure of FIG. 7, but lump-shaped intermetallic compounds (see arrows in FIG. 7) are large.

As described above, aluminum alloy containing some degree of Mn has excellent toughness, a preferable amount of Mn excludes 0%. Accordingly, in combination with the consideration based on FIGS. 4(A) and (B), a preferable Mn amount is in the range from not less than 0.01% to not more than 0.7%.

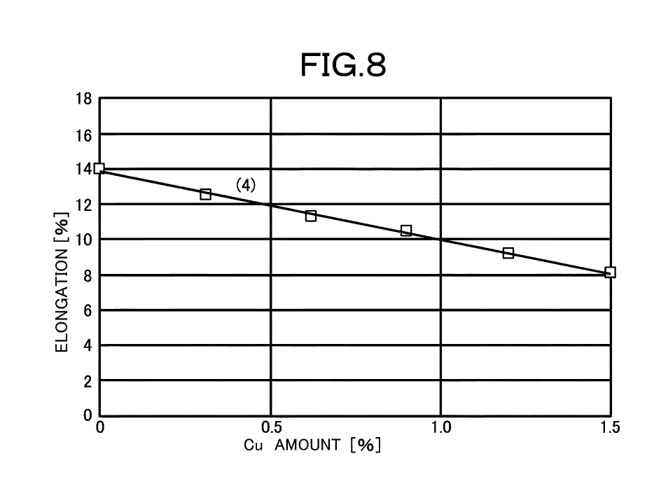

FIG. 8 shows a correlation between the Cu amount and the toughness with respect to the reference examples 1 to 6. (4) in FIG. 8 represents a linearly approximate curve.

In FIG. 8, there was obtained a result that higher toughness could be obtained as the Cu amount was smaller. From this result, the Cu amount is preferably small, and in consideration of the amount of Cu which is mixed as impurities when regenerated aluminum ingot material is used, the Cu amount is preferably equal to 1.0% or less. Furthermore, from the results of the examples 1 to 9, the Cu amount is most preferably equal to 0.6% or less.

The embodiments of the present invention have been described above, but the present invention is not limited to the above embodiments. In addition to the die-casting method (HDPC: High Pressure Die-Cast), not only a normal die-casting method, but also a high vacuum die-casting method may be applied.

### INDUSTRIAL APPLICABILITY

Aluminum alloy for vehicles according to the present invention has an elongation suitable for vehicle parts. Therefore, it can be used for parts for vehicles containing a motorcycle. When it is applied as a wheel for a motorcycle, this is particularly preferable. Furthermore, the aluminum alloy according to the present invention is not limited to wheels, but is preferably applied to chassis-based parts (swing arm, fork, bridge, etc.) to which toughness is required as vehicle parts for motorcycles. Furthermore, when Fe is contained, an effect of preventing seizure in die-casting is obtained. Therefore, this invention is particularly preferable to a case where vehicle parts are manufactured by aluminum die-casting.

### DESCRIPTION OF REFERENCE NUMERALS

10 wheel for motorcycle
11 hub
15 spoke
17 rim

1.-10. (canceled)

11. Aluminum alloy for a vehicle that contains Fe in the range from not less than 0.3 wt % to not more than 0.8 wt %, Mn in the range from not less than 0.2 wt % to not more than 0.4 wt %, Si in the range from not less than 6.0 wt % to not more than 12.0 wt %, Cu of not more than 1.0 wt %, Mg in the range from not less than 0.05 wt % to not more than 0.4 wt %, Zn in the range from not less than 0.3 wt % to not more than 1.0 wt %, and Al and unavoidable impurities as residuals, and is formed by die-casting, wherein an intermetallic compound size is equal to 15 μm or less, and the aluminum alloy has an elongation characteristic of 10% or more.

12. A part for a vehicle that is formed by die-casting with aluminum alloy for a vehicle that contains Fe in the range from not less than 0.3 wt % to not more than 0.8 wt %, Mn in the range from not less than 0.2 wt % to not more than 0.4 wt %, Si in the range from not less than 6.0 wt % to not more than 12.0 wt %, Cu of not more than 1.0 wt %, Mg in the range from not less than 0.05 wt % to not more than 0.4 wt %, Zn in the range from not less than 0.3 wt % to not more than 1.0 wt %, and Al and unavoidable impurities as residuals, wherein an intermetallic compound size is equal to 15 μm or less, and the aluminum alloy has an elongation characteristic of 10% or more.

13. The part for a vehicle according to claim 12, wherein the part is a wheel for a motorcycle.

14. The part for a vehicle according to claim 13, wherein a plate thickness of the part is set to 15 mm or less.

15. The part for a vehicle according to claim 12, wherein the part is a wheel for a motorcycle in which thicknesses of a spoke and a rim are set to 15 mm or less.

16. The part for a vehicle according to claim 14, wherein the part is a wheel for a motorcycle.

17. The part for a vehicle according to claim 13, wherein the part is a wheel for a motorcycle in which thicknesses of a spoke and a rim are set to 15 mm or less.

18. The part for a vehicle according to claim 14, wherein the part is a wheel for a motorcycle in which thicknesses of a spoke and a rim are set to 15 mm or less.
